(19) United States
(12) Patent Application Publication
(10) Pub. No.: US 2016/0349969 A1
(43) Pub. Date: Dec. 1, 2016

(54) Automated User Interface Experimentation

(71) Applicant: Cisco Technology, Inc., San Jose, CA (US)

(72) Inventors: Stephen Charles Tallamy, Sandhurst (GB); Olivier Jean Bernard Frebourg, Southampton (GB); Trevor George Smith, Twickenham (GB)

(21) Appl. No.: 14/726,566

(22) Filed: May 31, 2015

(51) Int. Cl. G06F 3/0484; G06F 3/0481; G06F 17/30; G06F 3/14

(52) U.S. Cl. CPC G06F 3/04842; G06F 3/1415; G06F 3/0481; G06F 17/3053

(57) ABSTRACT

In one embodiment, a method includes providing a variant user interface to a first subset of a plurality of user devices, wherein the variant user interface is based on baseline user activity data indicative of user activities associated with a baseline user interface provided to the plurality of user devices, obtaining variant user activity data indicative of user activities associated with the variant user interface, and generating, based on the variant user activity data, effect data indicative of an effect of the variant user interface on one or more of the user activities.

### TECHNICAL FIELD

The present disclosure relates generally to user interfaces, and in particular, to systems, methods and apparatuses enabling generation and testing of variations of user interfaces.

### BACKGROUND

The ongoing development, maintenance and expansion of network-based systems often involves providing more sophisticated user interfaces to users to allow them to access to increasing functionality. Further, user interactions with these interfaces generate an enormous amount of data that can be analyzed to gain insight into how the users interact with systems over a network.

Network operators or administrators may design and implement variations to the user interfaces and analyze the data generated from user interactions with the modified user interfaces to measure the effect of the variations. However, the conception and design of the variations is typically a manual operation based, not on data generated from user interactions, but on human insight. Accordingly, modification of the user interface to realize particular objectives is a slow process that often fails to appreciate variations that could realize the particular objectives.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of a data network in accordance with some implementations.

FIG. 2 is a block diagram of a server in accordance with some implementations.

FIG. 3 is an example activity graph in accordance with some implementations.

FIG. 4 is an example transition table in accordance with some implementations.

FIG. 5 is a flowchart representation of a method of providing a user interface in accordance with some implementations.

FIG. 6 is a flowchart representation of a method of determining the effect of a variant user interface in accordance with some implementations.

FIG. 7 is a flowchart representation of a method of performing an experiment with respect to a user interface in accordance with some implementations.

FIG. 8 is a block diagram of a computing device in accordance with some implementations.

In accordance with common practice various features shown in the drawings may not be drawn to scale, as the dimensions of various features may be arbitrarily expanded or reduced for clarity. Moreover, the drawings may not depict all of the aspects and/or variants of a given system, method or apparatus admitted by the specification. Finally, like reference numerals are used to denote like features throughout the figures.

### DESCRIPTION OF EXAMPLE EMBODIMENTS

Numerous details are described herein in order to provide a thorough understanding of the illustrative implementations shown in the accompanying drawings. However, the accompanying drawings merely show some example aspects of the present disclosure and are therefore not to be considered limiting. Those of ordinary skill in the art will appreciate from the present disclosure that other effective aspects and/or variants do not include all of the specific details of the example implementations described herein. While pertinent features are shown and described, those of ordinary skill in the art will appreciate from the present disclosure that various other features, including well-known systems, methods, components, devices, and circuits, have not been illustrated or described in exhaustive detail for the sake of brevity and so as not to obscure more pertinent aspects of the example implementations disclosed herein.

### Overview

Various implementations disclosed herein include apparatuses, systems, and methods for performing experiments with respect to a user interface. For example, in some implementations, a method includes providing a variant user interface to a first subset of a plurality of user devices, wherein the variant user interface is based on baseline user activity data indicative of user activities associated with a baseline user interface provided to the plurality of user devices, obtaining variant user activity data indicative of user activities associated with the variant user interface, and generating, based on the variant user activity data, effect data indicative of an effect of the variant user interface on one or more of the user activities.

In other implementations, a method includes determining an experiment with respect to a user interface based on user activity data indicative of user activities associated with the user interface, performing the experiment, generating effect data indicative of results of the experiment, and providing the effect data via an administrator interface.

### Example Embodiments

In order to allow users access to the functionality of a system over a network, many systems provide users with a user interface to access that functionality. In addition to allowing users to access the various functions of the system, the user interface may be designed or modified to further specific objectives, such as increasing the number of content sales or decreasing the number of user errors. User interactions with a user interface generate data that can be analyzed to gain insight into how the users interact with system, particularly with respect to objectives driving the design of the user interface.

In some implementations, a system that provides a user interface further includes functionality to automatically perform experiments with respect to the user interface. In some implementations, the system uses the data indicative of user interactions with the user interface to drive the initiation of experiments with respect to the user interface to address particular objectives. To that end, the system, upon receiving such data, automatically determines an experiment involving a variant to the user interface, automatically performs the experiment, and automatically analyzes subsequent data to determine the results of the experiment. In some implementations, the details and results of the experiment are provided to a system administrator with the option to adopt or reject the variant to the user interface in order to improve the user interface with respect to some objective. Iteratively performing experiments involving variants, in series and/or in parallel (and adopting variants having a positive effect) repeatedly and incrementally improves the user interface with respect to objectives selected by the administrator.

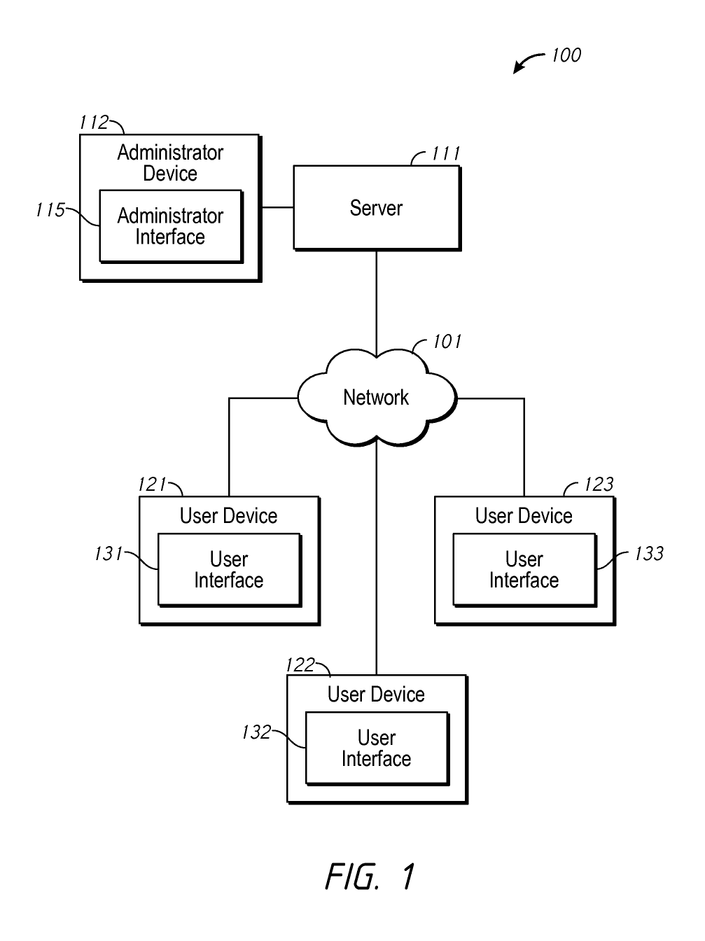

FIG. 1 is a block diagram of a data network 100 in accordance with some implementations. While certain specific features are illustrated, those of ordinary skill in the art will appreciate from the present disclosure that various other features have not been illustrated for the sake of brevity and so as not to obscure more pertinent aspects of the example implementations disclosed herein. To that end, the data network 100 includes a server 111 coupled, via a network 101, to a number of user devices 121-123. The network 101 includes any public or private LAN (local area network) and/or WAN (wide area network), such as an intranet, an extranet, a virtual private network, and/or portions of the Internet. Each user device 121-123 is a device including a suitable combination of hardware, firmware, and software for performing one or more functions. The server 111 provides, to each of the user devices 121-123 via the network 101, a user interface 131-133 that users of the user devices 121-123 can interact with via input devices and/or output devices of the user devices 121-123. In some implementations, the user interfaces 131-133 include a graphical user interface (GUI).

In some implementations, the user device 121 is a set-top box (STB) for, among other things, viewing television programming and/or videos. The user device 121 includes one or more input devices such as a remote control and/or buttons and one or more output devices such as a television display and/or LED (light emitting diode) indicators. In some implementations, the user interface 131 of the user device 121 is an electronic programming guide (EPG) that allows users to navigate scheduling information menus interactively, selecting and discovering programming by time, title, station or genre.

In some implementations, the user device 122 is a personal computer for, among other things, navigating the Internet. The user device 122 includes one or more input devices such as a mouse and/or keyboard and one or more output devices such as a monitor and/or speaker. In some implementations, the user interface 132 of the user device 122 is a website or a web application interface that allows users to interact with the user interface to view web-based content.

In some implementations, the user device 123 is a smartphone for, among other things, executing a mobile application (mobile app). The user device 123 includes one or more input devices such as a touchscreen and/or microphone and one or more output devices such as a display screen and/or speaker. In some implementations, the user interface 133 of the user device 123 is a mobile application interface that allows users to interact with the user interface to view content transmitted over a cellular network.

Although particular examples of user devices 121-123 and corresponding user interfaces 131-133 are provided above, it is to be appreciated that, in various implementations, aspects of this disclosure are implemented in other types of user devices and/or other types of user interfaces. For example, in some implementation, the user devices include point-of-sale terminals, automated teller machines, vending machines, smart watches, or any other user device. Further, in various implementations, the user devices 121-123 include other types of input devices and/or output devices than the example devices mentioned above.

In some implementations, the server 111 is coupled to an administrator device 112 that manages the server 111 and the user interfaces 131-133 provided by the server 111 to the user devices 121-123 via the network 101. Although illustrated as coupled directly to the server 111, in some implementations, the administrator device 112 is coupled to the server 111 via the network 101 or another network. The administrator device 112 includes an administrator interface 115 by which an administrator can manage the server 111 and the user interfaces 131-133 by providing various inputs and receiving various outputs. In some implementations, the administrator interface 115 includes a graphical user interface (GUI).

The server 111 receives interaction data from the user devices 121-123, via the network 101, indicative of user interactions with the user interfaces 131-133. In some implementations, the interaction data indicates particular user actions taken with respect to the user interfaces 131-133, such as key presses, mouse pointer movements, touch gestures, audio inputs, motion, etc. One or more user actions may be indicative of a user activity. For example, in some implementations, a series of user actions pressing the “channel down” button on a remote control while interacting with an EPG is indicative of channel surfing. As another example, in some implementations, a series of user actions pressing the “down arrow” while interacting with a website is indicative of scrolling a webpage. User activities include, but are not limited to, clicking a button on a webpage of website, visiting a webpage of a website, scrolling a webpage of a website, adding an item to a shopping cart of a website, purchasing a video-on-demand item through a website, web app, or EPG, channel surfing via an EPG, completing a sign-up process for a user account, reading some text, etc.

As noted above, the server 111 receives interaction data from the user devices 121-123, via the network 101, indicative of user interactions with the user interfaces 131-133. The interaction data includes data indicative of user actions and/or data indicative of user activities. When the interaction data includes data indicative of user actions, the server 111 processes the data to generate data indicative of user activities. In some implementations, the server 111 stores a set of rules to apply to the data indicative of user actions to generate the data indicative of user activities. In some implementations, each of the set of rules is associated with a user activity and specifies one or more user actions that make up the user activity. In some implementations, the server 111 applies statistical analysis to the data indicative of user actions to generate the data indicative of user activities. In some implementations, the statistical analysis identifies a set of user actions that are not expected behavior, but occur with enough frequency to constitute a user activity.

Thus, the server 111 obtains user activity data indicative of user activities performed by users interacting with the user interfaces 131-133. As noted above, the server, in some implementations, receives user activity data directly from the user devices 121-123 and, in some implementations, generates the user activity data based on data indicative of user actions received from the user devices 121-123. In some implementations, the server 111 receives the user activity data from another source. For example, in some implementations, the server 111 transmits the data indicative of user actions to a cloud-based processing service and receives user activity data in response.

In some implementations, the server 111 performs experiments to determine the effect on the user activities of variants applied to the user interfaces 131-133. In some implementations, for example, the server 111 identifies one or more target user activities that are to be encouraged or discouraged, selects one or more variants based on the one or more target user activities, and provides the user interface with or without the one or more variants to subsets of the user devices 121-123. Based on the user activity data returned from the subsets of the user devices 121-123, the server 111 determines the effect of the variant on the user activities. In some implementations, the result of an experiment (e.g., the effect of the variant on the user activities) are presented to the administrator (e.g., via the administrator interface 115) for adoption or rejection of the variant. Iteratively performing experiments involving variants, in series and/or in parallel (and adopting variants having a positive effect) repeatedly and incrementally improves the user interface 131-133 with respect to objectives selected by the administrator.

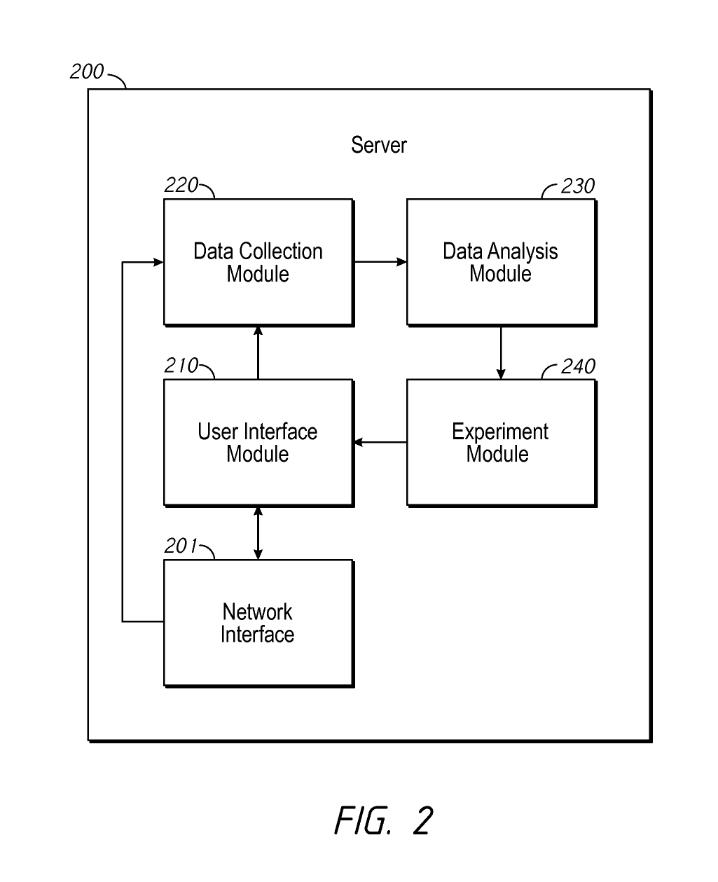

FIG. 2 is a block diagram of a server 200 in accordance with some implementations. In some implementations, the server 200 corresponds to server 111 of FIG. 1 and performs one or more of the functionalities described above. The server 200 includes a network interface 201 configured to transmit and receive data over a network. The network interface 201 transmits and receives data to one or more user devices and/or one or more administrator devices.

Although FIG. 2 illustrates the server 200 as a single unit, it is to be appreciated that the server 200 can be embodied as multiple distributed computing devices configured to perform the functions described herein. For example, in some implementations, the server 200 is a virtual server instantiated in a cloud-based computing system.

The server 200 includes a user interface module 210 configured to provide a user interface via a network. In some implementations, the user interface module 210 responds to user requests received via the network interface 201 to provide the user interface to each of a plurality of user devices. In some implementations, the user interface module 210 responds to administrator requests received via the network interface 201 to provide an administrator interface to an administrator device. In some implementations, the user interface and/or the administrator interface is a graphical user interface (GUI). Specifically, in some implementations, the user interface and/or the administrator interface is a network-based graphical user interface (GUI).

The server 200 includes a data collection module 220 that receives interaction data indicative of user interactions with the user interfaces. In some implementations, the interaction data is received by the network interface 201 from a plurality of user devices and is read by the data collection module 220. In some implementations, the interaction data is read by the user interface module 210 as part of the provision of the user interface and is provided by the user interface module 210 to the data collection module 220. In some implementations, the interaction data indicates particular user actions taken with respect to the user interfaces. As indicated above, one or more user actions may be indicative of a user activity. In some implementations, the interaction data includes user activity data indicative of user activities.

The data collection module 220 provides the interaction data to a data analysis module 230. In some implementations, the interaction data includes data indicative of user actions and the data analysis module 230 processes the data to generate data indicative of user activities. In some implementations, the data analysis module 230 accesses a set of rules to apply to the data indicative of user actions to generate the data indicative of user activities. In some implementations, the data analysis module 230 applies statistical analysis to the data indicative of user actions to generate the data indicative of user activities.

Thus, the data analysis module 230 obtains user activity data indicative of user activities performed by users interacting with the user interfaces provided by the user interface module 210. In some implementations, a user experience is a series of user activities performed by a user interacting with the user interface. Thus, in some implementations, the user activity data is sessionized and indicates, for a particular user device, an ordered series of user activities performed by a user interacting with the corresponding user interface. In some implementations, the user activity data includes such user activity data for a plurality of user devices.

In some implementations, the data analysis module 230 generates user experience data based on the sessionized user activity data. In some implementations, the user experience data is indicative of series of user activities performed by users interacting with the user interface provided by the user interface module 210. In some implementations, the user experience data include transition data indicative of paths through the user experience. In some implementations, the transition data is displayed to an administrator, e.g., via an administrator interface provided by the user interface module 210, to provide information regarding the prominent paths through the user experience.

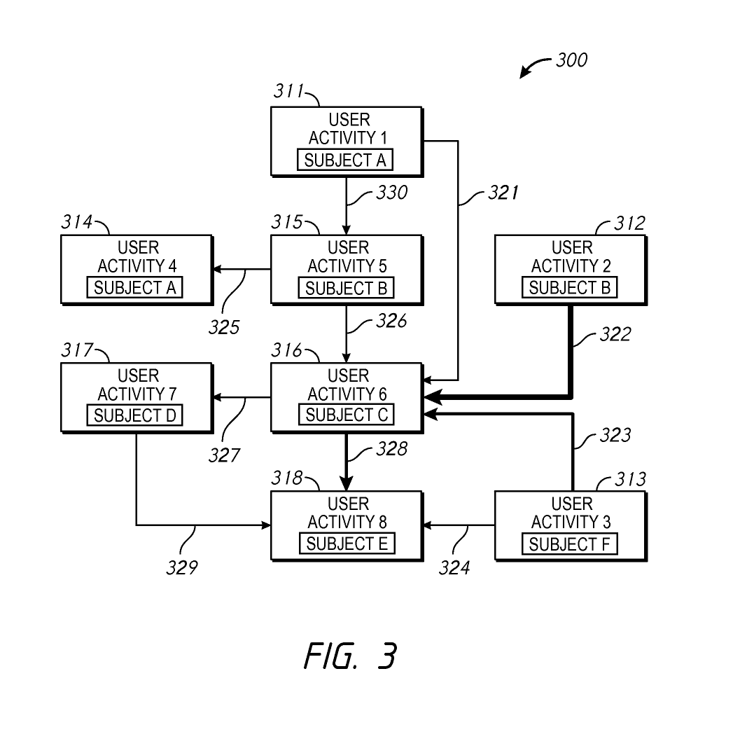

In some implementations, the transition data is displayed or stored, at least in part, as an activity graph including a number of nodes corresponding to user activities and a number of links between the nodes corresponding to transitions between the user activities. An example activity graph is shown in FIG. 3 and described in detail below.

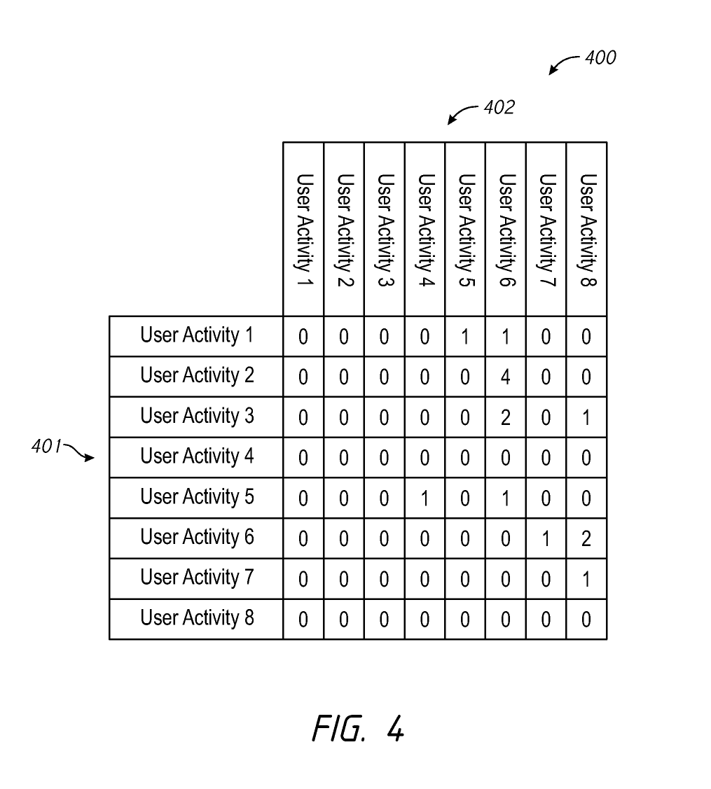

In some implementations, the transition data is stored, at least in part, as a transition table including a number of rows and a number of columns, each corresponding to a user activity. At the intersection of each row and column is an element that stores a value indicative of a number of times (as indicated by the sessionized user activity data) that users performed the user activity of the column following performance of the user activity of the row. As example transition table is shown in FIG. 4 and described in detail below.

The experiment module 240 receives the user experience data from the data analysis module 230, and based on the user experience data, generates and executes one or more experiments. In some implementations, the experiment module 240 selects one or more target user activities based on the user experience data. In some implementations, the experiment module 240 selects one or more variants to be applied to the user interface provided by the user interface module 210 to at least a subset of a plurality of user devices for the duration of an experiment. In some implementations, the experiment module 240 selects the subset of the plurality of user devices. In some implementations, the experiment module 240 selects a time to perform the experiment. The experiment module 240 controls the user interface module 210 to provide the user interface with the variant to at least a subset of the plurality of user devices for the duration of the experiment. In some implementations, the user interface module 210 provides the user interface without the variant to at least another subset of the plurality of user devices for the duration of the experiment.

The data collection module 220 receives experimental interaction data from the user devices indicative of user interactions with the user interfaces with the variant provided by the user interface module 210 for the duration of the experiment. In some implementations, the data collection module 220 also receives control interaction data from the user devices indicative of user interactions with the user interfaces without the variant provided by the user interface module 210 for the duration of the experiment.

The data analysis module 230 generates experimental user experience data based on the experimental interaction data. In some implementations, the data analysis module 240 also generates control user experience data based on the control interaction data.

In some implementations, the experiment module 240 compares the control user experience data with the experimental user experience data to determine the effect of the variant of the target user activities and/or other user activities. In some implementations, the experiment module 240 compares previously collected user experience data (which may be referred to as baseline user experience data) to the experimental user experience data to determine the effect of the variant on the target user activities and/or other user activities. In some implementations, the experiment module 240 compares both the control user experience data and the baseline user experience (which may be appropriately weighted) to determine the effect of the variant.

In some implementations, the results of the experiments (e.g., the effect of the variant on the user activities) are presented to the administrator for adoption or rejection of the variant, e.g., via an administrator interface provided via the network interface 201. Iteratively performing experiments involving variants, in series and/or in parallel (and adopting variants having a positive effect) repeatedly and incrementally improves the user interface provided by the user interface module 210 with respect to objectives selected by the administrator.

FIG. 3 is an activity graph 300 in accordance with some implementations. The activity graph can be displayed as a set of nodes and links between the nodes. Further, the activity graph can be stored as a graph data structure, e.g., in a graph database. The example activity graph 300 of FIG. 3 includes eight nodes 311-318 corresponding to eight user activities and ten links 320-329 between the nodes corresponding to transitions between the user activities. Each node 311-318 is associated with a user activity and includes data regarding the user activity, such as a definition or description of the user activity and/or a subject of the user activity, e.g., the part of the user interface which the user activity relates to. For example, in some implementations, the subject of a “purchase” activity includes the visual element (e.g. button) that that user activity relates to. As another example, in some implementations, the subject of a “reading” activity includes a section of text. In some implementations, each node 311-318 includes additional data regarding the user activity or other data. Each link 320-329 is associated with a value, illustrated by a line width of the link in FIG. 3, indicative of the number of times the transition between the user activities has occurred as indicated by the sessionized user activity data.

In some implementations, the value indicative of the number of times the transition between the user activities has occurred is equal to the number of times the transition between the user activities has occurred over a time period. In some implementations, the value is a metric of the number of times (rather than the number of times itself) that the transition has occurred. For example, in some implementations, a value of ‘0’ indicates an insignificant (yet, potentially non-zero) number of times, a value of ‘1’ indicates a small number of times, a value of ‘2’ indicates a medium number of times, and a value of ‘4’ indicates a large number of times.

The first node 311 corresponding to a first user activity includes data regarding the first user activity, including the subject of the first user activity (e.g., Subject A). From the first node 311, there are two links 320-321 respectively linking the first node 311 to a fifth node 315 corresponding to fifth user activity and a sixth node 316 corresponding to a sixth user activity. Each of the links 320-321 is associated with a value (e.g., ‘1’) indicative of the number of times the transition from the first user activity to the fifth user activity and sixth user activity has occurred as indicated by the sessionized user activity data.

The second node 312 corresponding to a second user activity includes data regarding the second user activity, including the subject of the second user activity (e.g., Subject B). From the second node 312, there is a link 322 linking the second node 312 to the sixth node 316. The link 322 is associated with a value (e.g., ‘4’) indicative of the number of times the transition from the second user activity to the sixth user activity has occurred as indicated by the sessionized user activity data.

The third node 313 corresponding to a third user activity includes data regarding the third user activity, including the subject of the third user activity (e.g., Subject F). From the third node 313, there are two links 323-324 respectively linking the third node 313 to the sixth node 316 and an eighth node 318 corresponding to an eighth user activity. The first of the links 323 is associated with a value (e.g., ‘2’) indicative of the number of times the transition from the third user activity to the sixth user activity has occurred as indicated by the sessionized user activity data. The second of the links 324 is associated with a value (e.g., ‘1’) indicative of the number of times the transition from the third user activity to the eighth user activity has occurred as indicated by the sessionized user activity data.

The fourth node 314 corresponding to a fourth user activity includes data regarding the fourth user activity, including the subject of the fourth user activity (e.g., Subject A). As illustrated by the first node 311 and the fourth node 314, in some implementations, two or more user activities may have the same subject.

The fifth node 315 corresponding to the fifth user activity includes data regarding the fifth user activity, including the subject of the fifth user activity (e.g., Subject B). From the fifth node 315, there are two links 325-326 respectively linking the fifth node 311 to the fourth node 315 and the sixth node 316. Each of the links 325-326 is associated with a value (e.g., ‘1’) indicative of the number of times the transition from the fifth user activity to the fourth user activity and sixth user activity has occurred as indicated by the sessionized user activity data.

The sixth node 316 corresponding to the sixth user activity includes data regarding the sixth user activity, including the subject of the sixth user activity (e.g., Subject C). From the sixth node 316, there are two links 327-328 respectively linking the sixth node 313 to the seventh node 316 corresponding to a seventh user activity and the eighth node 318. The first of the links 327 is associated with a value (e.g., ‘1’) indicative of the number of times the transition from the sixth user activity to the seventh user activity has occurred as indicated by the sessionized user activity data. The second of the links 328 is associated with a value (e.g., ‘2’) indicative of the number of times the transition from the sixth user activity to the eighth user activity has occurred as indicated by the sessionized user activity data.

The seventh node 317 corresponding to the seventh user activity includes data regarding the seventh user activity, including the subject of the seventh user activity (e.g., Subject D). From the seventh node 317, there is a link 329 linking the seventh node 317 to the eighth node 318. The link 329 is associated with a value (e.g., ‘1’) indicative of the number of times the transition from the seventh user activity to the eighth user activity has occurred as indicated by the sessionized user activity data.

The eighth node 318 corresponding to the eighth user activity includes data regarding the eighth user activity, including the subject of the eighth user activity (e.g., Subject E).

FIG. 4 is a transition table 400 in accordance with some implementations. The transition table can be displayed or stored as a tabular data structure. In some implementations, the tabular data structure may be part of a graph data structure storing an activity graph representation. For ease of understanding, the transition table 400 of FIG. 4 corresponds to the activity graph 300 of FIG. 3. It is to be appreciated that both the activity graph 300 and transition table 300 are only examples and that, in various implementations, other activity graphs and/or transition tables are generated based on transition data. Further, in some implementations, the transition data is stored or expressed in other ways.

The transition table 400 has a number of rows 401 and a number of columns 402, each row 401 and column 402 corresponding to a user activity. At the intersection of each row 401 and column 402 is an element that stores a value indicative of a number of times (as indicated by the sessionized user activity data) that a user performed the user activity of the column following performance of the user activity of the row.

In some implementations, the value is the total number of times that a user (any of a plurality of users) performed the user activity of the column following performance of the user activity of the row. In some implementations, the value is the number of times that a user performed the user activity of the column following performance of the user activity of the row within a set time period. In some implementations, the value is a metric of the number of times (rather than the number of times itself) that a user performed the user activity of the column following performance of the user activity of the row. For example, in some implementations, a value of ‘0’ indicates an insignificant (yet, potentially non-zero) number of times, a value of ‘1’ indicates a small number of times, a value of ‘2’ indicates a medium number of times, and a value of ‘4’ indicates a large number of times.

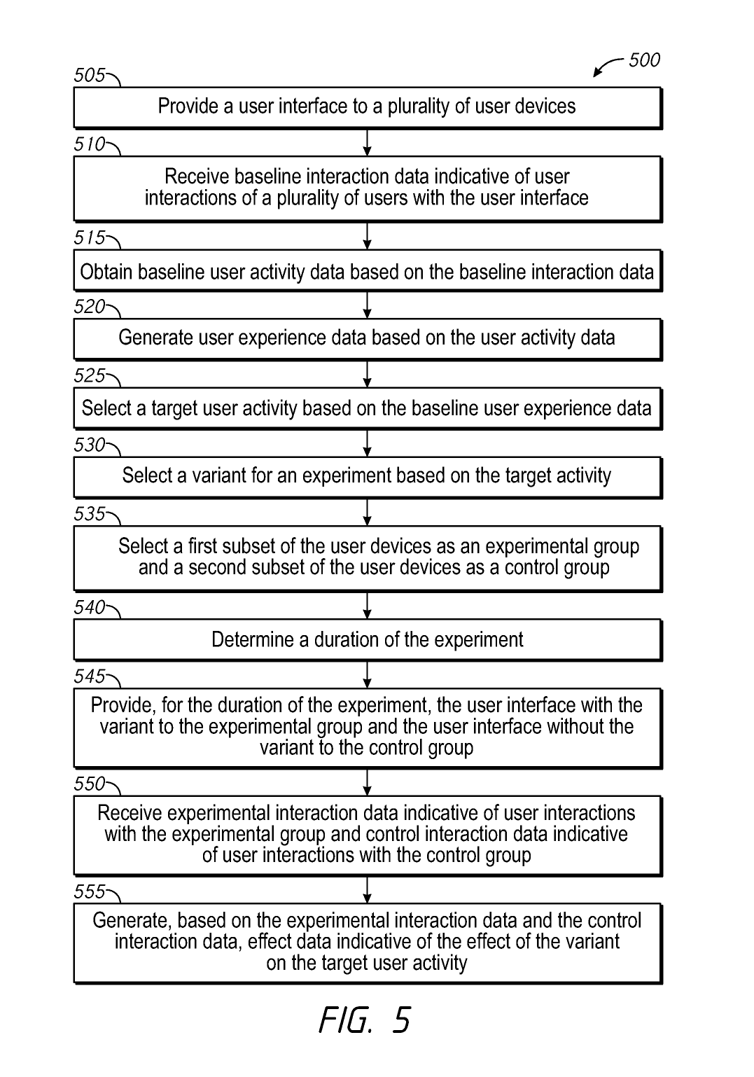

FIG. 5 is a flowchart representation of a method 500 of providing a user interface in accordance with some implementations. In some implementations (and as detailed below as an example), the method 500 is performed by a server, such as the server 111 of FIG. 1. In some implementations, the method 500 is performed by processing logic, including hardware, firmware, software, or a combination thereof. In some implementations, the method 500 is performed by a processor executing code stored in a non-transitory computer-readable medium (e.g., a memory). Briefly, the method 500 includes providing a user interface and performing an experiment with respect to the user interface.

The method 500 begins, in block 505, with the server providing a user interface to each of a plurality of user devices. In some implementations, the user interface is provided via a network and is a network-based user interface. In some implementations, the user interface is a graphical user interface (GUI). In providing the user interface, the server receives user inputs indicative of user interactions with the user interface and provides outputs based on the user inputs. In some implementations, the user interface is an electronic programming guide (EPG), a website, a web application interface, or a mobile application interface. In various implementations, the user interface includes other types of user interfaces.

At block 510, the server receives baseline interaction data indicative of user interactions of a plurality of users with the user interface via the plurality of user devices. The interaction data includes data indicative of key presses, mouse pointer movements, touch gestures, audio inputs, motion, or any other user input. In some implementations, the interaction data indicates that an input occurred and includes information about the input. For example, in some implementations, the interaction data indicates that user clicked a mouse and includes coordinates indicating where the mouse cursor was positioned on the screen when the user clicked the mouse. As another example, in some implementations, the interaction data indicates that user pressed a keyboard key and includes a character code indicating which key the user pressed.

At block 515, the server obtains baseline user activity data based on the baseline interaction data. In some implementations, the baseline interaction data includes data indicative of user actions and the server processes the data to generate data indicative of user activities. In some implementations, the baseline interaction data includes data indicative of user activities and the server obtains the baseline user activity data directly from the plurality of users.

At block 520, the server generates baseline user experience data based on the user activity data. In some implementations, the baseline user activity data is sessionized and indicates an ordered series of user activities performed by a user interacting with a particular user interface. In some implementations, the user activity data includes such user activity data for a plurality of users. In some implementations, the server generates the baseline user experience data based on the sessionized baseline user activity data.

In some implementations, the baseline user experience data is indicative of series of user activities performed by users interacting with the user interface. In some implementations, the baseline user experience data includes baseline transition data indicative of paths through the user experience. For example, in some implementations, the baseline transition data indicates, for a plurality of first user activities, a number of times that a user performed the first user activity following performance of each of a plurality of second user activities. Example depictions of transition data are illustrated by the activity graph 300 of FIG. 3 and the transition table 400 of FIG. 4.

At block 525, the server selects a target user activity based on the baseline user experience data. In some implementations, the target user activity is selected as a user activity to increase or decrease the occurrence of via experimentation. In some implementations, the server ranks the user activities based on user experience data. In some implementations, the server determines a ranking score for each of the user activities based on baseline user experience data. In various implementations, the server determines the ranking score in any of a number of ways.

In some implementations, user activities that are more likely to be performed are ranked higher than user activities that are less likely to be performed. In some implementations, the ranking score is higher for user activities having a larger number of transitions to the user activity than for user activities having a smaller number of transitions to the user activity. In particular, in some implementations, the ranking score is higher for a commonly performed user activity having a larger number of transitions to the commonly performed user activity than for an uncommonly performed activity having a smaller number of transitions to the uncommonly performed user activity. Following the example of FIGS. 3 and 4, the sixth user activity (which has transition metrics of ‘1’, ‘4’, ‘2’, and ‘1’ from the first, second, third, and fifth user activities, for a total of ‘8’) is ranked higher than the seventh user activity (which has a transition metric of ‘1’ from the sixth user activity). In some implementations, the ranking score is higher for user activities having a larger number of other user activities associated with a non-zero transmission metric to the user activity than for user activities having a smaller number of other user activities associated with a non-zero transmission metric to the user activity. Following the example of FIGS. 3 and 4, the eighth user activity (which has non-zero transition metrics from the third, sixth, and seventh user activities, for a total of three) is ranked higher than the fourth user activity (which has only one non-zero transition metric from the fifth user activity). User activities having a ranking score higher than a threshold are deemed a significant user activity.

In some implementations, the server stores, in association with one or more user activities, a desirability metric. In some implementations, the desirability metric is provided to the server by an administrator, e.g., via an administrator interface. In various implementations, the desirability metric is received at various times. In some implementations, the desirability metric is received along with rules specifying user actions that make up the user activity. As noted above, in some implementations, the server applies statistical analysis to data indicative of user actions to generate the data indicative of user activities. Thus, in some implementations, the server presents these user activities via the administrator interface and receives desirability metrics in response.

In some implementations, the server presents the user activities (or at least the significant user activities) via the administrator interface as a list in an order specified by the ranking. In some implementations, the server receives, via the administrator interface, a desirability metric for one or more of the user activities in the list. In some implementations, the desirability metric indicates whether the user activity is a user activity that is to be encouraged or discouraged. Encouraged user activities may be associated with a positive outcome (and a positive desirability metric) and discouraged user activities may be associated with a negative outcome (and a negative desirability metric). In some implementations, the desirability metric is a value of ‘1’ to indicate a desirable user activity, a value of ‘−1’ to indicate an undesirability user activity, and a value of ‘0’ to indicate a neutral user activity. For example, in some implementations, a goal user activity of purchasing a VOD item is given a desirability metric of ‘1’ and a problem user activity of visiting an error page is given a desirability metric of ‘−1’. In some implementations, there are multiple desirability metric values for user activities that are to be encouraged and/or multiple desirability metric values for user activities that are to be discouraged, indicative of an amount that the user activities are to be encouraged or discouraged. For example, in some implementations, a goal user activity of visiting an “About Us” page is given a desirability metric of ‘1’, a goal user activity of adding an item to a shopping cart is given a desirability metric of ‘5’, a problem user activity of receiving a 404 error message is given a desirability metric of ‘−1’, and a problem user activity of being unable to proceed to payment for an item in a shopping cart is given a desirability metric of ‘−10’.

In some implementations, the server selects the target user activity based on the ranking. In some implementations, the server selects the target user activity based on the ranking, weighted by the desirability metrics. Thus, in some implementations, selecting a target user activity include, determining a ranking score for each of a plurality of user activities based on the transition data, determining a desirability metric for each of the plurality of user activities, and selecting the target user activity based on the ranking score for each of the plurality of user activities and the desirability metric for each of the plurality of user activities.

At block 530, the server selects a variant for an experiment based on the target user activity. In some implementations, an administrator provides a set of variants to the server. Variants are modifications to the user experience that include, but are not limited to, changing the order of items in a list, changing a font parameter of a section of text (including font, font weight, font size, and/or font color), changing a background color of a button, discounting a price of a product, moving a section of the user interface to a different location, or adding a link to create an alternative navigation path.

In some implementations, the variants are associated with the user activities by the subject of the user activities. For example, in some implementations, the subject of a “purchase” activity includes the visual element (e.g. button) that that user activity relates to. Thus, in some implementations, associated variants include changing the size or color of the visual element, a location of the visual in the user interface, or a font parameter of the text of the visual element. As another example, in some implementations, the subject of a “reading” activity includes a section of text. Thus, in some implementations, associated variants include changing a font parameter or a formatting parameter of the text.

In some implementations, the server identifies user activities that transition to the target user activity based on the baseline user experience data. In particular, in some implementations, the server determines, based on the transition data, a plurality of transition user activities, the transition data indicating that users have performed the target user activity following performance of each of the plurality of transition user activities at least a threshold number of times. In some implementations, the server identifies as potential variants, those variants associated with the transition user activities and selects one of the potential variants as the variant.

In some implementations, each of the transition user activities is associated with a subject and each of the subjects is associated with one or more variants. Thus, in some implementations, the potential variants associated with the transition user activities identified by the server include the variants associated with the subjects of the transition user activities. Thus, the server identifies, as potential variants, variants of a subject of a user activity that is within the path through the activity graph leading to the target activity.

Referring to FIG. 3 as an example, assuming that the seventh user activity is selected as the target activity, the server identifies the sixth user activity as a transition user activity. In some implementations, the server further identifies the first user activity, the second user activity, the third user activity, and the fifth user activity as transition user activities based on the path from the corresponding nodes to the seventh node 317 through the sixth node 316. In contrast, the server may not identify the fourth user activity or the eighth user activity as transition user activities based on their position in a different branch of the activity graph 300.

In some implementations, the server identifies a set of subjects of the set of transition user activities. In some implementations, each transition user activity has one or more subjects. In some implementations, two or more transition user activities may have the same subject. Thus, in some implementations, the server identifies a set of subjects of the set of transition user activities that is not a one-to-one mapping. Thus, referring to the example above, where the seventh user activity is the target activity, the server may identify as the set of subjects, Subject A (as the subject of the first user activity), Subject B (as the subject of the second user activity and the fifth user activity), Subject C (as the subject of the sixth user activity), and Subject F (as the subject of the third user activity).

For each of the set of subjects, the server identifies one or more potential variants. Following the example above, in some implementations, Subject A is associated with a first variant, Subject B is associated with a second variant and a third variant, Subject C is also associated with a fourth variant, and Subject F is also associated with the first variant. Thus, the server identifies, as potential variants, the first variant, the second variant, the third variant, and the fourth variant.

In some implementations, the server ranks potential variants (e.g., by determining a ranking score for each of the potential variants) and selects the potential variant with the highest ranking as the variant. In some implementations, potential variants associated with user activities more frequently performed are ranked higher than potential variants associated with user activities less frequently performed. In some implementations, potential variants associated with user activities more frequently leading to the target user activity (as indicated by the transition data) are ranked higher than potential variants associated with user activities less frequently leading to the target user activity. Referring again to the example of FIG. 3, with the seventh user activity selected as the target user activity, a variant associated with the subject of the second user activity (e.g., the second variant or third variant associated with Subject B) may be ranked higher than a potential variant associated with the subject of the first user activity (e.g., the first variant associated with Subject A). In some implementations, each of the variants is associated with a metric provided by an administrator and the ranking is based, at least in part, on the provided metric.

At block 535, the server selects a first subset of the plurality of user devices as an experimental group and a second subset of the plurality of user devices as a control group. In some implementations, the server determines the first subset of the plurality of user devices based on the user activity data. For example, in some implementations, the server selects, as part of the first subset of the plurality of user devices, user devices of users that have performed the target user activity associated with the variant (e.g., as indicated by the user activity data). In some implementations, the server determines the first subset of the plurality of user devices randomly. In some implementations, the server determines a size of the first subset of the plurality of user devices and randomly selects a number of the plurality of user devices equal to the size. In some implementations, the server selects the second subset in a similar manner as selecting the first subset.

At block 540, the server determines a duration of the experiment. In some implementations, the server determines the duration of the experiment based on the user activity data. For example, in some implementations, the user activity data indicates a target user activity associated with the variant was performed at a particular time or day or a particular day of the week. Thus, in some implementations, the server determines a duration of the experiment as occurring during that particular time of day or during that particular day of the week. In some implementations, the server determines the duration of the experiment as a start trigger and an end trigger. In some implementations, each of the start trigger and end trigger is specific time. Thus, in some implementations, the server determines the duration of the experiment as a start time and an end time. For example, in some implementations, the server determines the duration of the experiment as starting immediately and ending in two weeks. As another example, in some implementations, the server determines the duration of the experiment as starting when traffic peaks and ending when traffic drops below a threshold (e.g., 50% of the peak traffic).

At block 545, the server provides, for the duration of the experiment, the user interface with the variant to the experimental group and the user interface without the variant to the control group. At block 550, the server receives experimental interaction data indicative of user interactions with the experimental group (e.g., the first subset of the plurality of user devices) and receives control interaction data indicative of user interactions with the control group (e.g., the second subset of the plurality of user devices).

At block 555, the server generates, based on the experimental interaction data and the control interaction data, effect data indicative of the effect of the variant on the target user activity. In some implementations, the effect data also indicates the effect of the variant on other user activities. In some implementations, the server processes the experimental interaction data to generate experimental user activity data, processes the control interaction data to generate control user activity data, and generates the effect data based on the results. In some implementations, the server processes the experimental interaction data to generate experimental user experience data (which, in some implementations, includes experimental transition data), processes the control interaction data to generate control user experience data (which, in some implementations, includes control transition data), and generates the effect data based on the results.

In some implementations, the effect data indicates that the variant has increased or decreased occurrence of the target user activity. In some implementations, the effect data indicates that the variant has increased or decreased the average amount of time users spend performing the target user activity. In some implementations, the effect data indicates that users more frequently or less frequently transition to the target user activity from another particular user activity. In various implementations, the effect data indicates other effects of the variant on the target user activity or other user activities.

In some implementations, the server provides the effect data via an administrator interface. In some implementations, the server provides an option allowing an administrator to adopt or reject the variant. Following block 555, the method 500 may return to block 525 where the server selects a next target user activity with respect to the user interface. Thus, the method 500 may iteratively select target user activities and execute experiments so as to reduce transitions to undesirable user activities and increase transitions to desirable user activities.

Further, although the method 500 has been described above for a single target user activity (and a single experiment), it is to be appreciated that, in some implementations, the method 500 is performed for multiple target user activities, either in series, in parallel, or both. In various implementations, experiments for multiple target user activities are performed sequentially, simultaneously, or overlapping in time. For example, in some implementations, selecting a target user activity (at block 525) is performed for multiple target user activities before the user interface with a correspondingly selected variant is provided (at block 545) for one of the target user activities.

The server may perform multiple experiments in a run order to reduce the time of execution by, e.g., using ranking data and segmentation of the user base to reduce the time required to perform multiple experiments. In some implementations, the server selects an experiment to perform based on an experiment priority. In some implementations, the experiment priority is based on the ranking of the variant (as described above with respect to 530). In some implementations, the experiment priority is based on the results of previously performed experiments. For example, in some implementations, if a previously performed experiment was successful in achieving the objective, related experiments are given a higher priority. Thus, in some implementations, variants are ranked based on the results of previous experiments.

In some implementations, the server selects an experiment to perform based on the duration (e.g., the timing) of the experiments (as described above with respect to block 540). For example, some experiments that have a lower priority rank may have a duration at a closer time than other higher priority experiments. In some implementations, the server selects an experiment to perform based on the subset of the user devices selected as an experimental group (as described above with respect to block 535). For example, two or more experiments may have non-overlapping experimental groups and may be performed simultaneously. In some implementations, the server uses this information to determine the run order so it can get the outcome of the full set of experiments in less time.

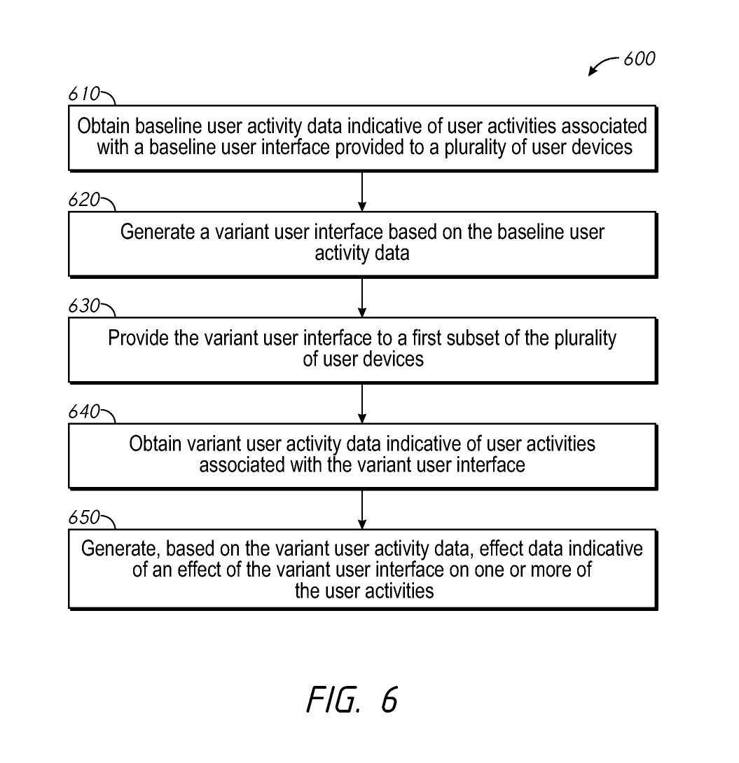

FIG. 6 is a flowchart representation of a method 600 of determining the effect of a variant user interface in accordance with some implementations. In some implementations (and as detailed below as an example), the method 600 is performed by a server, such as the server 111 of FIG. 1. In some implementations, the method 600 is performed by processing logic, including hardware, firmware, software, or a combination thereof. In some implementations, the method 600 is performed by a processor executing code stored in a non-transitory computer-readable medium (e.g., a memory). Briefly, the method 600 includes obtaining user activity data and performing an experiment with respect to the user interface based on the user activity data.

The method 600 begins, at block 610, with the server obtaining baseline user activity data indicative of user activities associated with a baseline user interface provided to a plurality of user devices. In some implementations, the baseline user activity data is indicative of user activities performed by a plurality of users interacting with a baseline user interface respectively provided to a plurality of user devices. In some implementations, the baseline user interface is a graphical user interface (GUI). In some implementations, the server provides the baseline user interface to each of the plurality of user devices and receives interaction data indicative of user interactions of a plurality of users interacting with the baseline user interface via the plurality of user devices. In some implementations, the server provides the baseline user interface to the plurality of user devices over a network and the user interface is a network-based user interface.

In some implementations, the interaction data includes data indicative of user actions and the server processes the data to generate the baseline user activity data indicative of user activities. In some implementations, the server stores a set of rules to apply to the data indicative of user actions to generate the baseline user activity data. In some implementations, each of the set of rules is associated with a user activity and specifies one or more user actions that make up the user activity. In some implementations, the server applies statistical analysis to the data indicative of user actions to generate the baseline user activity data.

In some implementations, the server receives baseline user activity data directly from the plurality of user devices. In some implementations, the server receives the baseline user activity data from another source. For example, in some implementations, the server transmits the data indicative of user actions to a cloud-based processing service and receives the baseline user activity data in response.

At block 620, the server generates a variant user interface based on the baseline user activity data. In some implementations, the server determines a variant based on the baseline user activity data and generates the variant user interface based on the baseline user interface and the variant. In some implementations, the variant user interface is the baseline user interface with the variant. In some implementations, the server determines the variant based on a target user activity. In some implementations, the server selects the target user activity based on baseline user experience data generated from the baseline user activity data. Thus, in some implementations, the server generates baseline user experience data indicative of a series of user activities associated with the baseline user interface provided to the plurality of user devices, selects a target user activity based on the baseline user experience data, and selects a variant based on the target user activity.

In some implementations, the baseline user activity data is sessionized and the server generates the baseline user experience data based on sessionized user activity data. In some implementations, the baseline user experience data includes transition data indicative of, for a plurality of first user activities, a number of times that a user performed the first user activity following performance of each of a plurality of second user activities. Example depictions of transition data are illustrated by the activity graph 300 of FIG. 3 and the transition table 400 of FIG. 4. In some implementations, the server selects a target user activity based on the baseline user experience data as described above with respect to block 525 of FIG. 5 and selects a variant associated with the target user activity as described above with respect to block 530 of FIG. 5.

In particular, in some implementations, selecting the target user activity includes determining a ranking determining a ranking score for each of plurality of user activities based on the transition data, determining a desirability metric for each of the plurality of user activities, and selecting the target user activity based on the ranking score for each of the plurality of user activities and the desirability metric for each of the plurality of user activities. In some implementations, the ranking score is higher for a commonly performed user activity having a larger number of transitions to the commonly performed user activity than for an uncommonly performed activity having a smaller number of transitions to the uncommonly performed user activity. In some implementations, determining the desirability metric for each of the plurality of user activities includes receiving the desirability metric for each of the plurality of user activities via an administrator interface.

In some implementations, selecting the variant includes determining, based on the transition data, a plurality of transition user activities, the transition data indicating that users have performed the target user activity following performance of each of the plurality of transition user activities at least a threshold number of times, determining a plurality of subjects of the plurality of transition user activities, determining a plurality of potential variants, each of the plurality of potential variants associated with at least one of the plurality of subjects, determining a ranking score for each of the plurality of potential variants, and selecting, from the plurality of potential variants, the variant based on the ranking score for each of the plurality of potential variants.

At block 630, the server provides the variant user interface to a first subset of the plurality of user devices. As described above, in some implementations, the variant user interface is based on the baseline user activity data indicative of user activities associated with the baseline user interface provided to the plurality of user devices. In some implementations, the server determines the first subset of the plurality of user devices based on the baseline user activity data. In some implementations, the baseline user activity data indicates that users of the first subset of the plurality of user devices have performed a target user activity associated with the variant. In some implementations, the server determines the first subset of the plurality of user devices randomly. In some implementations, the server determines a size of the first subset of the plurality of user devices. In some implementations, the server randomly selects a number of the plurality of the plurality of user devices equal to the size.

In some implementations, the server provides a control user interface (e.g., the baseline user interface or another user interface without the variant) to a second subset of the plurality of user devices. In some implementations, the second subset of the plurality of user devices includes the user devices not included in the first subset.

In some implementations, the server determines a duration based on the baseline user activity data, wherein the variant user interface is provided to the first subset of the plurality of user devices for the duration. In some implementations, the baseline user activity data indicates a target user activity associated with the variant was performed at a particular time or day or a particular day of the week. In some implementations, the server determines a duration as occurring during that particular time of day or during that particular day of the week. In some implementations, the server determines the duration as a start trigger and an end trigger. In some implementations, each of the start trigger and end trigger is specific time. Thus, in some implementations, the server determines the duration as a start time and an end time. For example, in some implementations, the server determines the duration as starting immediately and ending in two weeks. As another example, in some implementations, the server determines the duration as starting when traffic peaks and ending when traffic drops below a threshold (e.g., 50% of the peak traffic).

At block 640, the server obtains variant user activity data indicative of user activities associated with the variant user interface. In some implementations, the server obtains variant user activity data indicative of user activities performed by the plurality of users (or a subset thereof) interacting with the variant user interface via the first subset of the plurality of user devices during the duration. In some implementations, the variant user activity data is obtained in the same manner as the baseline user activity data as described above with respect to block 610.

In some implementations, the server obtains control user activity data indicative of user activities associated with the control user interface. For example, in some implementations, the server obtains control user activity data indicative of user activities performed by the plurality of users (of a subset thereof) interacting with a user interface without the variant via the second subset of the plurality of user devices for the duration. In some implementations, the control user activity data is obtained in the same manner as the user activity data as described above with respect to block 610.

At block 650, the server generates, based on the variant user activity data, effect data indicative of an effect of the variant user interface on one or more of the user activities. In some implementations, the server generates the effect data by comparing the variant user activity data to the baseline user activity data obtained in block 610. In some implementations, the server generates the effect data by comparing the variant user activity data to control user activity data. In some implementations, the effect data is indicative of an effect of the variant user interface on a target user activity associated with the variant applied to generate the variant user interface.

In some implementations, the effect data indicates that the variant user interface has increased or decreased occurrence of one or more of the user activities. In some implementations, the effect data indicates that the variant user interface has increased or decreased the average amount of time users spend performing one or more of the user activities. In some implementations, the effect data indicates that users more frequently or less frequently transition to one or more of the user activities from others of the one or more of the user activities. In various implementations, the effect data indicates other effects of the variant on the one or more user activities.

In some implementations, the server provides the effect data via an administrator interface for adoption or rejection of the variant user interface in order to improve the baseline user interface. Iteratively performing the method 600 (and adopting variants having a positive effect) repeatedly and incrementally improves the user interface with respect to objectives selected by the administrator.

Although the method 600 has been described above with respect to a single variant and two subsets of the plurality of user devices, e.g., A/B testing, in some implementations, the method 600 is used to perform multivariate testing in which different combinations of variants are provided to different subsets of the plurality of user devices.

Thus, in some implementations, the method 600 further includes providing a second variant user interface to a second subset of the plurality of user devices, wherein the second variant user interface is based on the baseline user activity data, and obtaining second variant user activity data indicative of user activities associated with the second variant user interface. In some implementations, the effect data is further based on the second variant user activity data and is further indicative of the effect of the second variant user interface on the one or more of the user activities.

In some implementations, providing the second variant user interface to the second subset of the plurality of user devices includes providing a user interface with a second variant and a first variant to a first portion of the second subset of the plurality of user devices and providing a user interface with the second variant and without the first variant to a second portion of the second subset of the plurality of user devices.

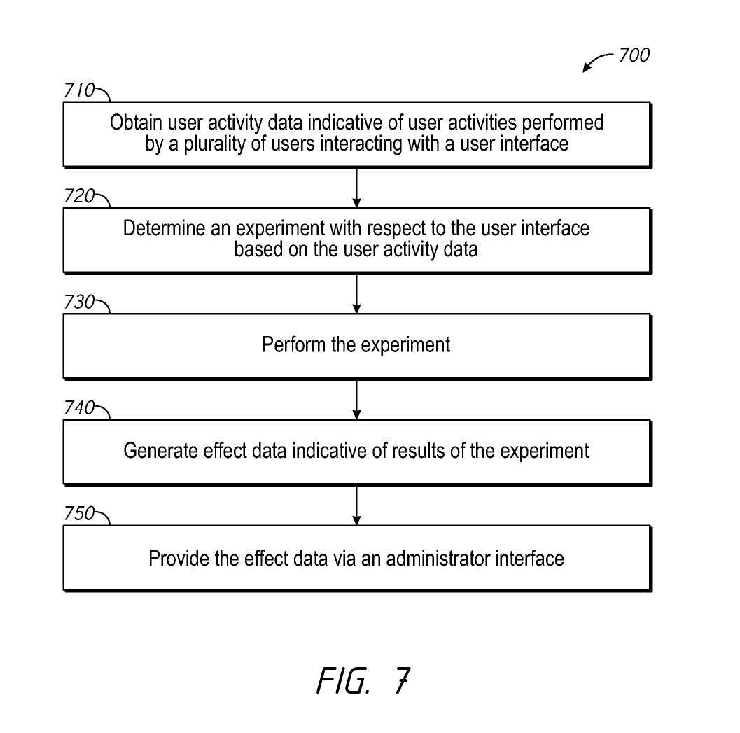

FIG. 7 is a flowchart representation of a method 700 of performing an experiment in accordance with some implementations. In some implementations (and as detailed below as an example), the method 700 is performed by a server, such as the server 111 of FIG. 1. In some implementations, the method 700 is performed by processing logic, including hardware, firmware, software, or a combination thereof. In some implementations, the method 700 is performed by a processor executing code stored in a non-transitory computer-readable medium (e.g., a memory). Briefly, the method 700 includes providing a user interface and performing an experiment with respect to the user interface.

The method 700 begins, at block 710, with the server obtaining user activity data indicative of user activities associated with a user interface. In some implementations, the step at block 710 is performed as described above with respect to block 610 of FIG. 6.

At block 720, the server determines an experiment with respect to the user interface based on the user activity data. In some implementations, determining an experiment includes generating a variant user interface (or a set of variant user interfaces). In some implementations, generating the variant user interface includes determining a variant and generating the variant user interface based on the user interface and the variant. The variants are one or more things that can be changed within the user experience. Example variants include, but are not limited to, changing the font size of some text, altering the price of a product, adding a link to create alternate navigation paths, etc. In some implementations, determining an experiment includes determining an objective. The objective is a measurable outcome that is to be achieved. Example objectives include, but are not limited to, increasing user sign-up, increasing the number of items added to a shopping cart, increasing the number of purchased products, decreasing the number of error page visits, decreasing the number of times a “back” button is pressed, decreasing network load at peak times, decreasing the number of steps of an activity (e.g., reducing an average number of clicked performed by a user to purchase an item), etc.

In some implementations, determining an experiment includes determining a duration. The duration is when the experiment is to start and end. Example durations include, but are not limited to, starting immediately and running for two weeks, starting at peak traffic and ending when traffic drops 50%, running four consecutive Tuesdays between 6:00 pm and 8:00 pm, etc. In some implementations, determining an experiment includes determining a target group. The target group is the section of user devices to be subject to the experiment. In some implementations, the target group includes an experimental group and a control group. In some implementations, the target group includes various subsets for various combinations of multiple variants. Target groups include, but are not limited to, 10% of user devices, user devices used by females between the ages of 21 and 35, user devices used frequently, etc.

In some implementations, the server determines the experiment with a small target group to get an early indicator of success ahead of other groups that do not frequently perform the activities under test. In a subsequent experiment, the server determine the same experiment, but with a different target group or expanded target group to confirm the result.

At block 730, the server performs the experiment. The server performs the experiment by (1) providing the variant user interface to at least a subset of the target group for the duration of the experiment and (2) obtaining variant user activity data indicative of user activities associated with the variant user interface. In some implementations, the server performs the experiment by providing the variant user interface to an experimental group and a user interface without the variant to a control group for the duration of the experiment.

At block 740, the server generates effect data indicative of the results of the experiment. In some implementations, the effect data is indicative of the effect of the variant user interface. In some implementations, the effect data is indicative of the effect of the variant user interface on the objective. In some implementations, the effect data indicates that the objective was achieved or not achieved. In some implementations, the effect data indicates that the variant user interface had no effect.

In some implementations, the effect data is indicative of the effect of the variant user interface on one or more user activities. In some implementations, the effect data indicates that the variant user interface has increased or decreased occurrence of one or more user activities. In some implementations, the effect data indicates that the variant user interface has increased or decreased the average amount of time users spend performing one or more user activities. In some implementations, the effect data indicates that users more frequently or less frequently transition to one or more of the user activities from others of the one or more user activities. In various implementations, the effect data indicates other effects of the variant on the one or more user activities.

At block 750, the server provides the effect data via an administrator interface. In some implementations, the server provides an option allowing an administrator to adopt or reject the variant user interface. Following block 750, the method 700 may return to block 720 where the server selects a next experiment with respect to the user interface. Thus, the method 700 may iteratively select and perform experiments to reduce transitions to undesirable user activities and increase transitions to desirable user activities. Iteratively performing experiments involving variants, in series and/or in parallel (and adopting variants having a positive effect) repeatedly and incrementally improves the user interface with respect to objectives selected by the administrator.

In various implementations, multiple experiments are performed sequentially, simultaneously, or overlapping in time. For example, in some implementations, determining an experiment (at block 720) is performed for multiple experiments before the experiment is performed (at block 730) for one of the multiple experiments. Thus, in some implementations, performing the experiment (at block 730) includes selecting one or more of a plurality of determined experiments to perform.

In some implementations, the server selects an experiment to perform based on an experiment priority. In some implementations, the experiment priority is based on a ranking of the variant (as described above with respect to 530 of FIG. 5). In some implementations, the experiment priority is based on the results of previously performed experiments. For example, in some implementations, if a previously performed experiment was successful in achieving the objective, related experiments are given a higher priority. Thus, in some implementations, variants are ranked based on the results of previous experiments.

In some implementations, the server selects an experiment to perform based on the duration (e.g., the timing) of the experiments. For example, some experiments that have a lower priority rank may have a duration at a closer time than other higher priority experiments. In some implementations, the server selects an experiment to perform based on the target groups of the experiments. For example, two or more experiments may have non-overlapping targets groups and may be performed simultaneously. In some implementations, the server uses this information to determine the run order so it can get the outcome of the full set of experiments in less time.

In some implementations, selecting an experiment to perform includes selecting multiple experiments to perform in parallel. Similarly, in some implementations, performing the experiment (in block 730) includes performing multiple experiments in parallel. In some implementations, the server determines how many experiments to perform based on parameters stored by the server, such as minimum target group sizes or a maximum number of active experiments.

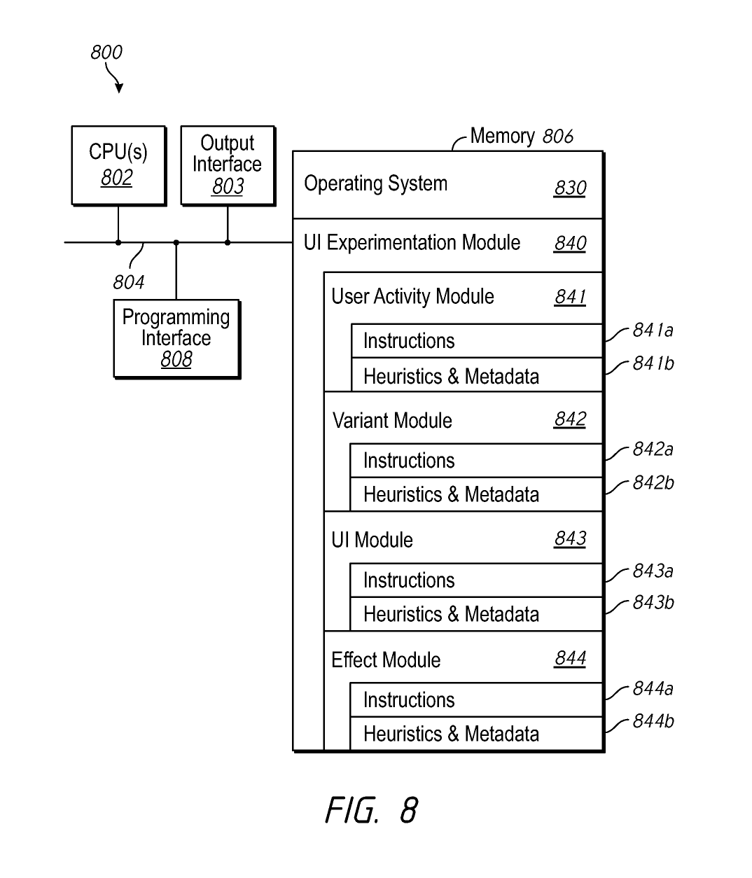

FIG. 8 is a block diagram of a computing device 800 in accordance with some implementations. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 800 includes one or more processing units (CPU's) 802 (e.g., processors), one or more output interfaces 803, a memory 806, a programming interface 808, and one or more communication buses 804 for interconnecting these and various other components.

In some implementations, the communication buses 804 include circuitry that interconnects and controls communications between system components. The memory 806 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806 comprises a non-transitory computer readable storage medium. Moreover, in some embodiments, the memory 806 or the non-transitory computer readable storage medium of the memory 806 stores the following programs, modules and data structures, or a subset thereof including an optional operating system 830 and a user interface experimentation module 840. In some embodiment, one or more instructions are included in a combination of logic and non-transitory memory. The operating system 830 includes procedures for handling various basic system services and for performing hardware dependent tasks. In some implementations, the user interface experimentation module 840 is configured to perform one or more experiments with respect to a user interface. To that end, the user interface experimentation module 840 includes a user activity module 841, a variant module 842, a user interface module 843, and an effect module 844.

In some implementations, the user activity module 841 is configured to obtain user activity data indicative of user activities performed by a plurality of users interacting with a user interface on a plurality of user devices. To that end, the user activity module 841 includes a set of instructions 841a and heuristics and metadata 841b. In some implementations, the variant module 842 is configured to determine a variant based on the user activity data. To that end, the variant module 842 includes a set of instructions 842a and heuristics and metadata 842b. In some implementations, the user interface module 843 is configured to provide a user interface to one or more of the plurality of user devices. To that end, the user interface module 843 includes a set of instructions 843a and heuristics and metadata 843b. In some implementations, the user interface module 843 in configured to provide a baseline user interface to the plurality of user devices and the user activity module 841 is configured to obtain baseline user activity data indicative of user activities associated with the baseline user interface. In some implementations, the user interface module 843 is configured to provide a variant user interface to a first subset of the plurality of user devices and the user activity module 841 is configured to obtain variant user activity data indicative of user activities associated with the variant user interface. In some implementations, the effect module 844 is configured to generate, based on the experimental user activity data, effect data indicative of an effect of the variant on one or more of the user activities. To that end, the effect module 844 includes a set of instructions 844a and heuristics and metadata 844b.

Although the user interface experimentation module 840, the user activity module 841, the variant module 842, the user interface module 843, and the effect module 844 are illustrated as residing on a single computing device 800, it should be understood that in variant implementations, any combination of the user interface experimentation module 840, the user activity module 841, the variant module 842, the user interface module 843, and the effect module 844 reside in separate computing devices. For example, in some implementations each of the user interface experimentation module 840, the user activity module 841, the variant module 842, the user interface module 843, and the effect module 844 reside on a separate computing device.

Moreover, FIG. 8 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
providing a variant user interface to a first subset of a plurality of user devices, wherein the variant user interface is based on baseline user activity data indicative of user activities associated with a baseline user interface provided to the plurality of user devices;
obtaining variant user activity data indicative of user activities associated with the variant user interface; and
generating, based on the variant user activity data, effect data indicative of an effect of the variant user interface on one or more of the user activities.

2. The method of claim 1, further comprising providing the effect data via an administrator interface for adoption or rejection of the variant user interface in order to improve the baseline user interface.

3. The method of claim 1, further comprising:
providing a control user interface to a second subset of the plurality of user devices; and
obtaining control user activity data indicative of user activities associated with the control user interface,
wherein the effect data is generated based on the variant user activity data and the control user activity data.

4. The method of claim 1, further comprising determining the first subset of the plurality of user devices based on the baseline user activity data, wherein the baseline user activity data indicates that users of the first subset of the plurality of user devices have performed a target user activity associated with the variant user interface.

5. The method of claim 1, further comprising:
receiving baseline interaction data indicative of user interactions associated with the baseline user interface provided to the plurality of user devices; and
generating the baseline user activity data based on the baseline interaction data.

6. The method of claim 1, further comprising:
determining a variant based on the baseline user activity data; and
generating the variant user interface based on the baseline user interface and the variant.

7. The method of claim 6, wherein determining the variant comprises:
generating, based on the baseline user activity data, transition data indicative of, for a plurality of first user activities, a number of times that users have performed the first user activity following performance of each of a plurality of second activities;
selecting a target user activity based on the transition data;
selecting a variant associated with the target user activity.

8. The method of claim 7, wherein selecting the target user activity comprises:
determining a ranking score for each of a plurality of user activities based on the transition data;
determining a desirability metric for each of the plurality of user activities; and
selecting the target user activity based on the ranking score for each of the plurality of user activities and the desirability metric for each of the plurality of user activities.

9. The method of claim 8, wherein the ranking score is higher for a commonly performed user activity having a larger number of transitions to the commonly performed user activity than for an uncommonly performed activity having a smaller number of transitions to the uncommonly performed user activity.

10. The method of claim 8, wherein determining the desirability metric for each of the plurality of user activities includes receiving the desirability metric for each of the plurality of user activities via an administrator interface.

11. The method of claim 7, wherein selecting the variant comprises:
determining, based on the transition data, a plurality of transition user activities, the transition data indicating that users have performed the target user activity following performance of each of the plurality of transition user activities at least a threshold number of times;
determining a plurality of subjects of the plurality of transition user activities;
determining a plurality of potential variants, each of the plurality of potential variants associated with at least one of the plurality of subjects;
determining a ranking score for each of the plurality of potential variants; and
selecting, from the plurality of potential variants, the variant based on the ranking score for each of the plurality of potential variants.

12. The method of claim 1, wherein the baseline user interface comprises a network-based graphical user interface.

13. The method of claim 1, wherein the baseline user interface comprises at least one of an electronic programming guide, a website, a web application interface, or a mobile application interface.

14. The method of claim 1, further comprising:
providing a second variant user interface to a second subset of the plurality of user devices, wherein the second variant user interface is based the baseline user activity data; and
obtaining second variant user activity data indicative of user activities associated with the second variant user interface;
wherein the effect data is further based on the second variant user activity data and is further indicative of an effect of the second variant user interface on the one or more of the user activities.

15. A system comprising:
a network interface configured to provide a user interface to a plurality of user devices;
one or more processors; and
a non-transitory memory comprising instructions that when executed cause the one or more processors to perform operations including:
controlling the network interface to provide a variant user interface to a first subset of a plurality of user devices, wherein the variant user interface is based on baseline user activity data indicative of user activities associated with a baseline user interface provided to the plurality of user devices;
obtaining variant user activity data indicative of user activities associated with the variant user interface; and
generating, based on the variant user activity data, effect data indicative of an effect of the variant user interface on one or more of the user activities.

16. The system of claim 15, the operations further comprising:
generating, based on the baseline user activity data, transition data indicative of, for a plurality of first user activities, a number of times that users have performed the first user activity following performance of each of a plurality of second activities;
selecting a target user activity based on the transition data;
selecting a variant associated with the target user activity; and
generating the variant user interface based on the baseline user interface and the variant.

17. The system of claim 16, wherein selecting the target user activity comprises:
determining a ranking score for each of a plurality of user activities based on the transition data;
determining a desirability metric for each of the plurality of user activities; and
selecting the target user activity based on the ranking score for each of the plurality of user activities and the desirability metric for each of the plurality of user activities.

18. A method comprising:
determining an experiment with respect to a user interface based on user activity data indicative of user activities associated with the user interface;
performing the experiment;
generating effect data indicative of results of the experiment; and
providing the effect data via an administrator interface.

19. The method of claim 18, wherein determining the experiment comprises:
generating a variant user interface;
determining a target group of the experiment; and
determining a duration of the experiment.

20. The method of claim 19, wherein performing the experiment comprises:
providing the variant user interface to at least a subset of the target group for the duration of the experiment; and
obtaining variant user activity data indicative of user activities associated with the variant user interface.
